(19) United States
(12) Patent Application Publication
(10) Pub. No.: US 2010/0235378 A1
(43) Pub. Date: Sep. 16, 2010

(54) MEDICAL ASSESSMENT SUPPORT SYSTEM AND METHOD

(75) Inventors: John M. Armstrong, Junction City, KS (US); Ramona R. Leibnitz, Junction City, KS (US)

Correspondence Address: MORRISON & FOERSTER LLP, 755 PAGE MILL RD, PALO ALTO, CA, 94304-1018, US

(73) Assignee: LEAD HORSE TECHNOLOGIES, INC., Junction City, KS (US)

(21) Appl. No.: 12/438,530

(22) PCT Filed: Aug. 22, 2007
(86) PCT No.: PCT/US07/76583

§ 371 Date: Feb. 23, 2009

Related U.S. Application Data
(60) Provisional application No. 60/823,194, filed on Aug. 22, 2006.

(51) Int. Cl. G06F 17/30

(52) U.S. Cl. 707/769; 707/E17.014

(57) ABSTRACT

The invention is directed to a medical assessment support system. In one embodiment, a user inputs a query that identifies an adverse event that a patient has experienced and the ailments (diseases, disorders, symptoms, conditions etc.) that the patient has experienced. In response, the system causes one or more database searches to be performed to identify one or more possible causes of the adverse event for a patient with the identified ailments. In another embodiment, the user inputs a combination of one or more drugs that a patient has taken and one or more ailments that the patient has experienced. The system operates to determine if there is an adverse event associated with the specified combination and reports any such adverse event to the user. The system retains a copy of any such report for comparison to later searches so as to avoid reporting the same possible adverse event multiple times. The system conducts any such search on a predetermined schedule or can do so at the request of the user. In another embodiment, the system integrates adverse event-drug-ailment associations with electronic medical record (EMR) systems to identify, to health care providers or users, patients who may be potentially at risk for those adverse events.

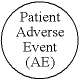

### FIELD OF THE INVENTION

The invention relates to a computer based medical assessment support system for receiving patient related data provided by a user, processing the data to identify sources of information that may impact the treatment of a patient, and providing the user with information that may be useful in treating the patient.

### BACKGROUND OF THE INVENTION

In some cases, a patient is treated and subsequently experiences an adverse event, i.e., a deterioration in the patient's condition. Currently, there are a number of computer systems available for analyzing whether there is a causal relationship between the adverse event and the treatment.

With reference to FIG. 1, one such system allows a user to specify the adverse event that the patient is experiencing or has experienced. In response, the system performs a database search to identify all of the sources of information in the database that refer to the adverse event and provides the results of the search to the user. For example, if a user specifies “heart palpitations” as an adverse event, the system searches a database to identify all of the sources of information in the database that refer to “heart palpitations” and provides the results of the search to the user.

With reference to FIG. 2, another system that is currently available allows a user to specify a drug that is or has been administered to a patient and an adverse event that was subsequently experienced by the patient. In response, the system searches a database of Pharmaceutical Package Inserts (“PPI”), the written material prepared by the manufacturer of a prescription drug and that accompanies the dispensation of the drug to a patient, for a discussion of the adverse event within the PPI of the specified drug. For example, if a user specifies “bleeding” as the adverse event and the drug as warfin sodium, the system searches the database of PPIs for the warfin sodium PPI and determines if the PPI for warfin sodium identifies bleeding as an adverse event. The results of the search are provided to the user.

With reference to FIG. 3, yet another system that is currently known determines whether there are any known adverse events associated with a combination of drugs. In this system, the user enters the two or more drugs that a patient is taking or has taken. The system uses this information to search for known adverse events involving a combination or combinations of the specified drugs. The results of the search are provided to the user. For instance, if the user indicates that the patient is taking or has taken “drug A” and “drug B”, the system searches a database to determine if there is one or more known adverse events associated with a patient that has taken “drug A” and “drug B,” and reports the results to the user.

### SUMMARY OF THE INVENTION

The invention is directed to a medical assessment support system that is capable of providing a more refined assessment as to whether the cause of an adverse event is related to a treatment that a patient is undergoing or has undergone to a user of the system. The treatment that is provided to a patient can take any number of forms. Commonly, the treatment is in the form of a drug or drugs that have been administered to the patient. The term “drug” includes, but is not limited to, any therapeutic reagent, whether a small molecule, a biologic, a homeopathic concoction, or any substance that can be administered therapeutically. The treatment can also be in the form of a therapy, such as radiation therapy. Typically, the user of the system is a health care provider (“HCP”). However, the system can be used or adapted for use by individuals that are not HCPs, such as the patient.

In one embodiment, the system comprises a communication interface that provides the system with the ability to: (a) communicate with a user; and (b) communicate with a source of information that may have information relating to one or more adverse events. The system further comprises a processing engine that receives a query from a user via the communication structure, searches one or more sources of information that may have information relating to the query, and transmits the results of the search to the user via the communication interface. Also part of the system is a data structure that contains the information that is searched by the processing engine in response to a query. Typically, the data structure is comprised of one or more databases and the recording medium that holds the database(s). It should be appreciated that the communication interface, processing engine, and data structure can be integrated into a structure that is capable of being located within a confined space or distributed over a network. Further, the system is capable of functioning within a system in which the communication interface facilitates communications with one or more users over a wide-area network (e.g., the Internet), a local-area network, or as a stand-alone system that is capable of operating without a network environment.

The query that is received by the system specifies one or more adverse events that a patient has experienced subsequent to treatment and the ailment(s) (i.e., diseases, disorders, symptoms, conditions, etc.) that the patient is known to be experiencing and for which the patient is being treated. The system searches one or more sources of information to identify information that exhibits a correlation between each of the specified adverse events and each of the specified ailments. The results of the search, which may be either positive or negative, are communicated to the user via the communication interface. In some cases, the results will identify a drug or drugs that are used to treat the ailment and are known to have some relationship to a specified adverse event. In many instances, this type of result typically provokes a more focused discussion between an HCP and the patient as to the patient's drug treatment regimen.

In another embodiment of the system, the query that is received and processed by the system specifies: (a) one or more adverse events that a patient has experienced subsequent to treatment; (b) the ailment(s) (i.e., diseases, disorders, symptoms, conditions, etc.) that the patient is known to be experiencing and for which the patient is being treated; and (c) the treatments that are or have been applied to the patient. The processing engine causes a search of one or more sources of information to identify information that exhibits (a) a correlation between each of the specified adverse events and each of the specified ailments; and (b) a correlation between each of the specified adverse events and each of the specified treatments. The results of the search, which may be either positive or negative, are communicated to the user via the communication interface. In some instances, the results relating to the search for a correlation between an adverse event and a specified ailment will identify a drug or drugs that have some relationship to a specified event and were not identified in the query. This type of result commonly results in further investigation into the patient's drug treatment regimen.

In a further embodiment of the system, the query that is received and processed by the system specifies one or more adverse events and the drugs and/or treatment(s) to which the patient is known to have been subjected. In response to the received query, the processing engine causes a search of one or more sources of information to identify information that exhibits a correlation between each of the specified adverse events and each of the specified drugs and/or treatment(s). The results, positive or negative, are communicated to the user via the communication interface. It should be appreciated that, when multiple drugs are specified, the system provides the results for all of the specified drugs at one time, thereby avoiding multiple searches.

Another embodiment of the system further comprises a query expansion processing engine that implements an ontology to expand the terms that are used by the processing engine in causing a search or searches of one or more information sources, thus potentially identifying information that would not have been identified if the search were limited to the terms set forth in the query as submitted. For example, if the query is “elevated liver function tests,” an ontology could expand the search terms or phrases to include: elevated liver enzymes, liver toxicity, hepatotoxicity, abnormal liver tests, jaundice etc. In the case of a static ontology, the processing engine performs the search based on the query and the results from applying the ontology to the query in an effort to expand the terms and/or phrases that are subsequently searched. It is also feasible to allow the user to amend the results of the ontology-based expansion of search terms before and/or after the search is conducted. The amendment can comprise removing terms or phrases and/or adding terms or phrases to the results of the application of the query to an ontology, thus altering the structure of the ontology. As an alternative or supplement to the ontology processing engine is a natural language processing engine (“NLP”) that recognizes the context of the query and, in so doing, is able to derive or suggest alternative terms or phrases for searching, whereby the results returned to the user can be more in the intended context than results yielded by use of an ontology processing engine alone.

A further embodiment of the system is capable of alerting a user that the information upon which a response to a query of the user had relied has changed, thus alerting the user that any decision made by the user based on the response may need to be amended. For instance, if the response to a query indicated that a reference identified in a search indicated that the adverse event specified in the query was not known to be associated with a drug that was also specified in the query, but the reference was subsequently amended to indicate that the specified adverse event was now known to be associated with the specified drug, the system would inform the user of this change so the user could consider whether any change in the course of action taken in response to the query was needed. In one embodiment, a query is stored together with information that identifies the references relied upon in providing the response to the query. The system also stores an “old” copy of each reference that has been relied upon in generating the response and, on occasion, retrieves a “new” copy of the reference from the source of the reference, and compares the “old” copy to the “new” copy. If there has been a change in the reference, the user is notified and provided with the new information.

In another embodiment, the system is capable of alerting a user that an adverse event has been reported to be associated with a drug, two or more drugs, an ailment, two or more ailments, or combinations thereof. The user specifies the combination of drug, drugs, ailment, and ailments that is of interest. The processing engine 26 then conducts one or more searches at specified times, typically on a daily basis, to identify adverse event reports that satisfy the user's specifications. If an adverse event report is identified that satisfies the user's specifications, the result is reported to the user. The result is also stored and compared to the results from subsequent searches to determine if the subsequent searches are identifying any new adverse event reports that should be reported to the user. In any event, once the user is apprised of such an adverse event report, the user can then make a decision as to whether or not to search their medical record system, electronic (EMR) or otherwise, to identify patients that are potentially at risk. Alternatively, the system can store the user's EMRs, de-identified or otherwise, and, either automatically or upon authorization of the user, search the EMRs to identify the patients that are or may be at risk and report the results to the user, who can then take whatever action may be appropriate.

In a further embodiment, the system comprises an EMR “hit reporter” that allows the system to identify those situations in which a search was conducted of a user's EMR system or a user's de-identified EMRs and the search identified one or more individuals that are potentially at risk of an adverse event based upon the search conducted pursuant to the user's specification of the drug, drugs, ailment, ailments, or combinations thereof that are of interest.

### BRIEF DESCRIPTION OF THE DRAWINGS

FIG. 1 illustrates the input, the adverse event, to a known system for identifying a cause or causes associated with an adverse event experienced by an individual;

FIG. 2 illustrates the inputs, the adverse event and the drug that the individual is or has taken, to a known system for identifying whether the drug is or could be the cause of the adverse event experienced by an individual;

FIG. 3 illustrates the inputs, the adverse event and the drugs that the individual is or has taken, to a known system for identifying whether a drug-drug interaction is or could be the cause of an adverse event experienced by an individual;

FIG. 4 illustrates an embodiment of the system of the invention;

FIG. 5A illustrates the inputs, adverse event and ailment(s), that form a query that is processed by the system illustrated in FIG. 4;

FIG. 5B illustrates the method implemented by the system shown in FIG. 4 in processing a query as illustrated in FIG. 5A;

FIG. 6 illustrates the inputs, adverse event and drugs/treatment(s), that form a query that is processed by the system illustrated in FIG. 4;

FIG. 7 illustrates the inputs, adverse event(s), drug(s), and ailment(s) that form a query that is processed by the system illustrated in FIG. 4;

FIG. 8 is an example of an ontology that is capable of being used to expand a query that identified elevated liver function tests as an adverse event;

FIG. 9 is an example of an amendment to the ontology illustrated in FIG. 8 that has added terms to the ontology;

FIGS. 10A and 10B illustrate a query, an ontology-based search term expansion, the results of a natural language processor search or mining operation based on the query and the expanded search terms, the unprioritized results of the search or mining operation, and the prioritized results of the search or mining operation.

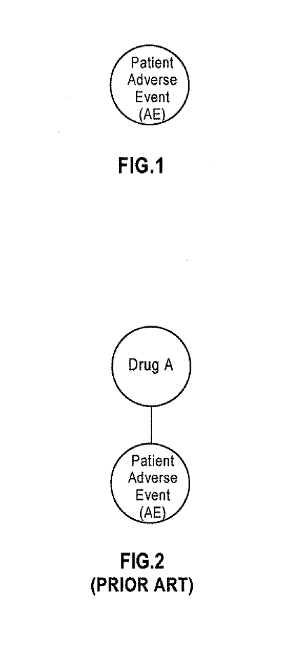

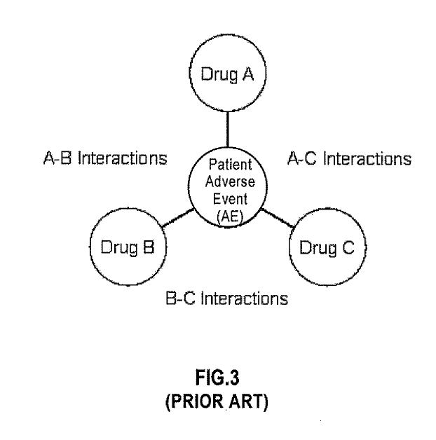

### DETAILED DESCRIPTION

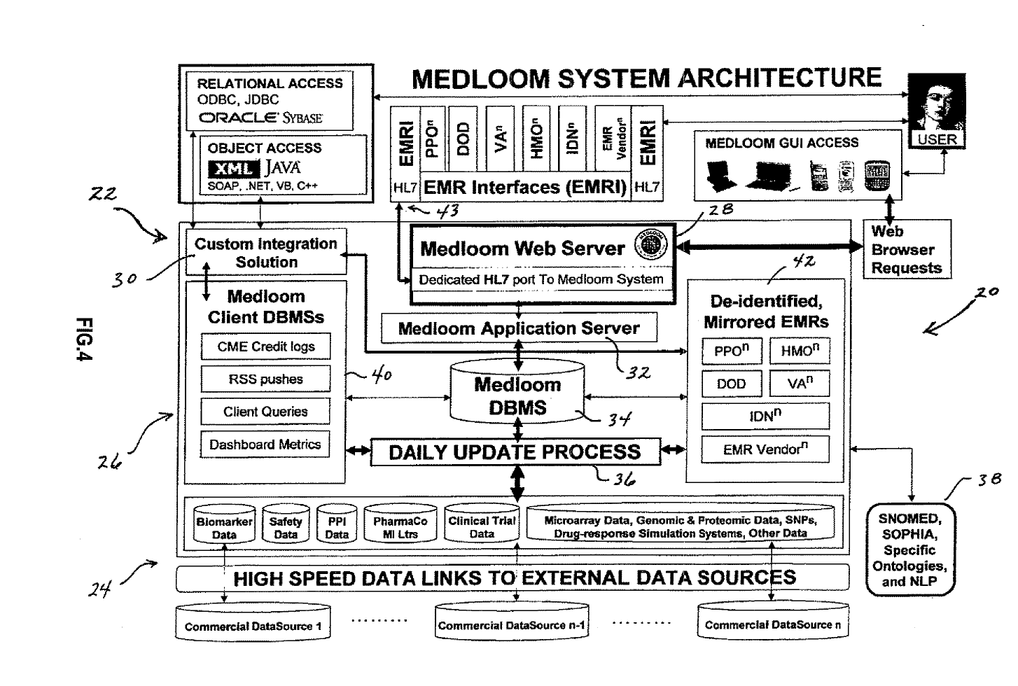

FIG. 4 illustrates an embodiment of a medical assessment support system for providing information relating to adverse events according to the invention. The embodiment of the system is hereinafter referred as system 20. The system 20 is comprised of (a) a user interface 22 that facilitates communications between the system 20 and an electronic or computing device associated with a user, (b) a data interface 24 that facilitates communications between the system 20 and one or more sources of data or information that are used to service a query that a user communicates to the system 20 over the user interface 22, and (c) a processing engine 26 that causes one or more searches of data or information sources to be conducted in response to a user query submitted over the user interface 22 and provides the results of the search or searches to the user over the user interface 22.

With continuing reference to FIG. 4, the user interface 22 is comprised of a Web server 28 that is capable of communicating with a client Web browser enabled electronic or computing device that is associated with a user. The electronic or computing devices that the server 28 is capable of communicating with include, but are not limited to, personal computers, PDAs, and cell phones that are capable of running a Web browser. The server 28 provides the client browser with a display of a form that contains fields that are linked to a Data Base Management System via Cache Server Pages (CSP). The server 28 and client browser maintain a one-to-one association that includes, but not limited to the following: (1) a drug information entry field(s); (2) an ailment information entry field(s); (3) a data source information entry field(s); and (4) an Adverse Event information entry field(s). All fields are linked to information stored internally in the DBMS. It should be appreciated that the Web server 28 can be replaced or supplemented with another type of server should communications with one or more users need to be conducted over a network (wide-area or local-area) other than the Web. The Web server 28 is also capable of communicating with an electronic or computing device that is associated with a user and capable of HL7 messaging, a messaging standard that is widely used in the healthcare industry. The server 28 is adaptable to other messaging protocols that are present in the healthcare industry or are adopted by the healthcare industry in the future. The server 28 is illustrated as a single server with a web browser port and an HL7 port. However, it should be appreciated that the server 28 can comprise multiple servers each with one or more ports.

The user interface 22 is also comprised of a custom integration solution interface 30 that allows a user to bypass the server 28 and directly access the database management system or systems associated with the processing engine 26. The custom integration solution interface 30 accepts queries that are in accordance with relational database or object-oriented database protocols. For example, the interface 30 is capable of receiving relational database queries that utilize ODBC or JDBC protocols for SQL-type queries and transmitting responses in an SQL format. The interface is also capable of receiving queries based on JAVA, C++, VB, SOAP, .NET etc. and transmitting responses in the appropriate format. The interface 30 is capable of being adapted to integrate with other protocols should the need arise. The ability to process relational or object-oriented database queries is realized by basing the processing engine 26 on CACHE, which is protocol-intelligent, i.e., capable of recognizing the protocol upon which a query is based. It should be appreciated that any other system that is protocol-intelligent could also be employed.

The system 20 provides for communication with a user by a browser port and an HL7 port that are each associated with the server 26 and the custom integration solution interface 30. It should be appreciated that the system 20 can be adapted to employ a subset of these various interfaces for communicating with an electronic or computing device associated with a user. Further, the system can be adapted to employ other interfaces for communicating with an electronic or computing device associated with a user that are now available or may in the future become available.

With continuing reference to FIG. 4, the data interface 24 is used to transmit requests for data or information to data sources, which are typically commercial data sources but may also include private, proprietary, or public data sources, and receive data or information from these sources that is utilized to build one or more databases that are part of the processing engine 26. In the illustrated embodiment, the data interface 24 is used to transmit requests to data sources that provide biomarker data, safety data, pharmaceutical package insert (PPI) data, pharmaceutical company medical information (MI) letters, white papers (not shown), clinical trial data, microarray data, genomic and/or proteomic data, single nucleotide polymorphisms (SNPs), drug-response simulation systems, etc. and receive the responses to any such requests. The data interface 24 is capable of transmitting requests and receives responses to one or more data sources that provide a subset of the noted types of data or information. The data interface 24 is also capable of being adapted to transmit requests and receive responses to one or more data sources that provide different types of data from the noted types of data or information. In the illustrated embodiment, the data interface 24 is a back end communication interface that supports all major communication protocols including HL7, XML, JDBC, ODBC and others. The data interface 24 has the ability to communicate with disparate external systems and uses internal class structure to parse and merge data into the DBMS quickly and efficiently. The DBMS stores the data in a variety of different ways (object, relational tables, and/or other) and can quickly respond to relational or object queries.

With continuing reference to FIG. 4, the processing engine 26 comprises: (a) an application server 32 that processes each query presented by a user via the server 28; (b) a database management system (DBMS) 34, (c) an update processor 36 that updates one or more databases maintained by the system 20 at specified times, typically, daily, (d) an ontology and/or natural language processor 38, (e) a client database management system 40 that is capable of causing a search or searches for adverse events based upon a user specified combination of drug(s) and ailment(s), a search or searches based on user specified adverse event(s) and at least one of an ailment(s) and drug(s), providing metrics to users that quantify the benefit of the system to the user, and monitoring continuing medical education credits for users that are health care providers based on the use of system, and (f)(i) a de-identified electronic medical record database 42 that contains the electronic medical records of patients of, for example an HMO, that have been de-identified, i.e., cannot be associated with an individual by the individual's name or other identifying information, such as residential address and/or (f)(ii) an application program interface (API) that allows access to an electronic medical record database (via an electronic medical record interface 43), de-identified or otherwise, that resides outside the system 20 but that is accessible to the system 20. In the illustrate embodiment, the processing engine 26 is a multi-dimensional Post Data Base Management System that stores data as object (Objects) and tables (SQL Relational). Data can be accessed directly using object oriented languages (.net, Java, XML etc.) and/or database languages that adhere to the SQL, DBMS relational industry standard. The DBMS 34 utilizes a transactional bit-map indexing scheme to enhances user response time.

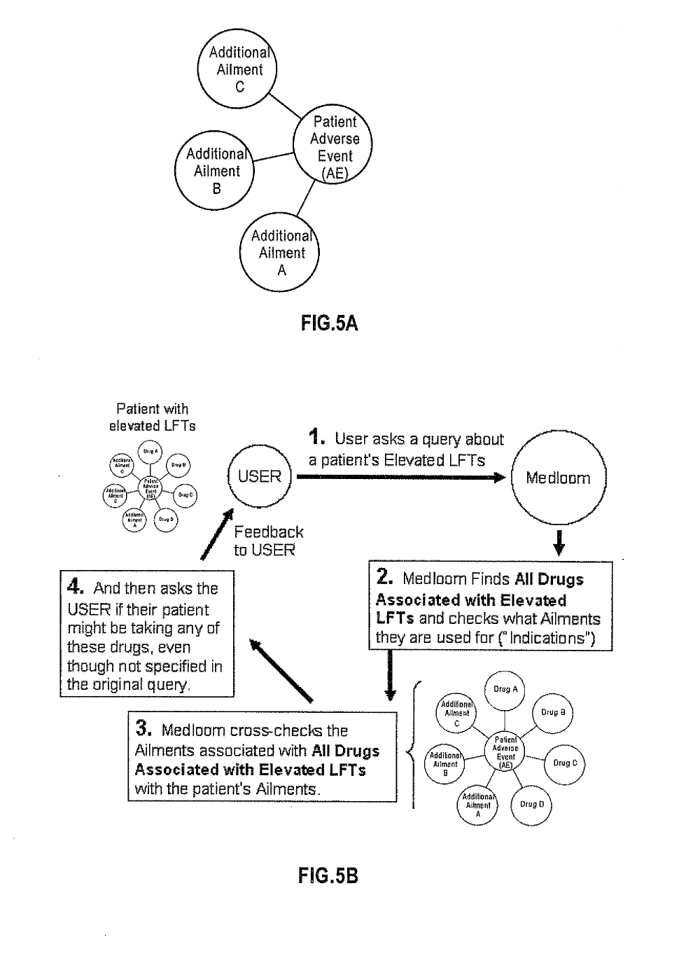

In the illustrated embodiment, one or more elements of the processing engine 26 are capable of responding to a number of different types of queries from a user. With reference to FIGS. 5A and 5B, one type of query that the processing engine 26 handles is a query that is comprised of an adverse event that a patient has experienced and the known ailments of the patient. The processing engine 26 operates to conduct one or more database searches of the databases either maintained by the system 20 or available to the system 20 to identify sources of information that indicate possible causes of the specified adverse event in the context of the specified ailments and/or comorbidities. The search may, for example, identify one or more drugs in which there is a correlation between the specified adverse event and the specified ailments. The results of the search are transmitted to the user's electronic or computing device. FIGS. 5A and 5B illustrate the process in the case when the specified adverse event is elevated liver function tests and the patient has ailments A-C.

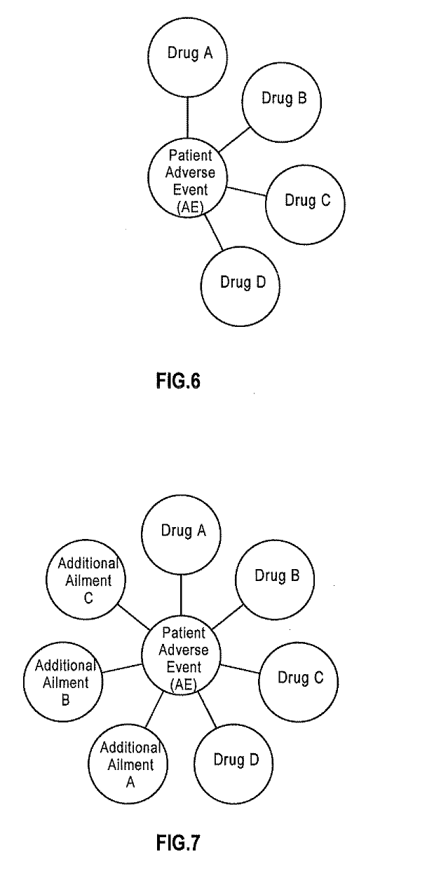

With reference to FIG. 6, another type of query that the processing engine 26 is capable of addressing is a query comprised of an adverse event and the drugs and/or treatment(s) to which a patient is known to have been subjected. The processing engine 26 operates to conduct one or more database searches of the databases either maintained by the system 20 or available to the system 20 to identify sources of information that indicate that there is a. relationship between the specified adverse event and the drugs and/or treatments to which the patient has been subjected. The results of the search are transmitted to the user's electronic or computing device.

With reference to FIG. 7, yet another type of query that the processing engine 26 is capable of handling is a query comprised of an adverse event, the drugs and/or treatment(s) to which a patient is known to have been subjected, and the known ailments of the patient. In this case, the processing engine 26 operates to conduct one or more database searches of the databases either maintained by the system 20 or available to the system 20 to identify sources of information that indicate that there is a relationship between the specified adverse event and the drugs and/or treatments to which the patient has been subjected. In addition, the processing engine 26 operates to conduct one or more database searches of the databases either maintained by the system 20 or available to the system 20 to identify sources of information that indicate possible causes of the specified adverse event in the context of the specified ailments. Among the possible causes can be Over-the-Counter (OTC) drugs or treatments, herbals, and prescription pharmaceuticals not necessarily specified by the patient, by the healthcare professional, or in the patient's medical record. The results of the searches are transmitted to the electronic or computing device associated with the user.

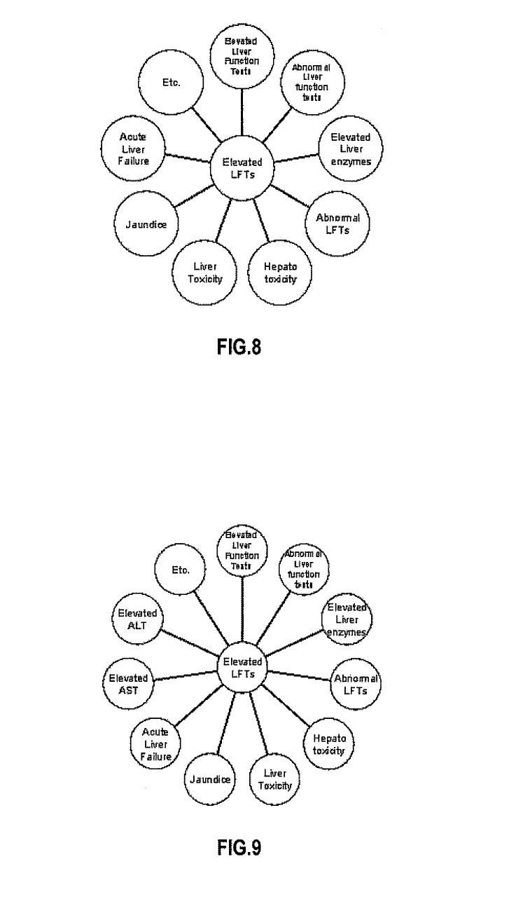

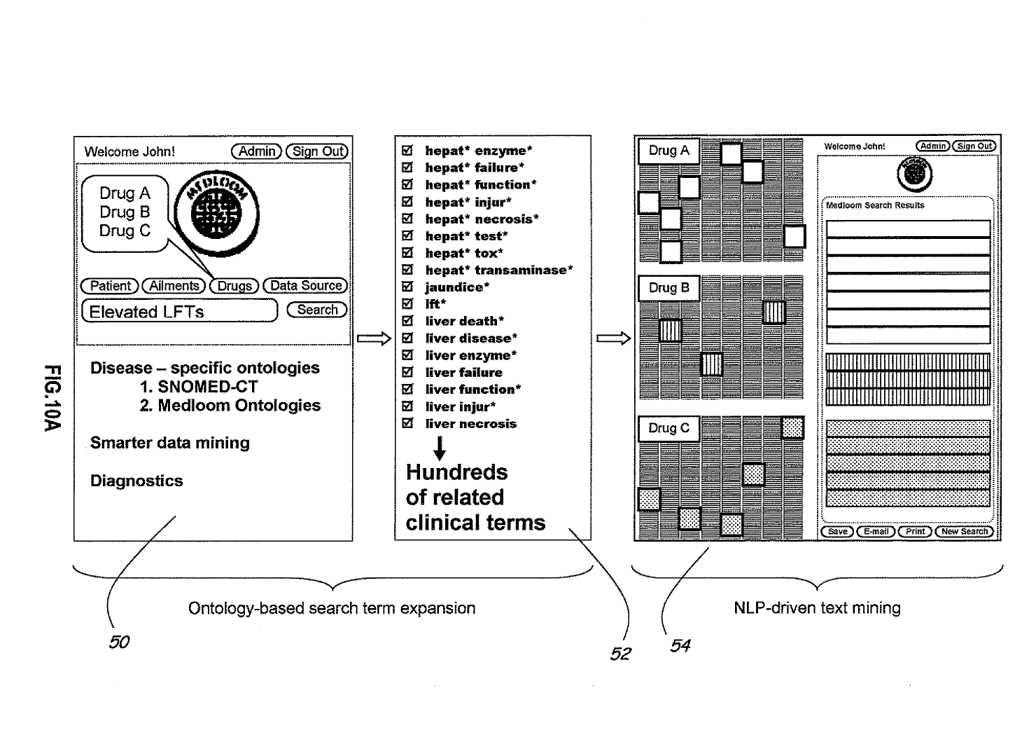

With reference to FIGS. 8 and 9, any query submitted by a user can be subjected to the ontology and/or natural language processor 38 to identify related search terms in an effort to capture more sources of information that are relevant to the query than would be found using only the terms of the query. FIG. 8 illustrates an ontology for elevated liver function tests that suggests a number of other terms that may yield additional sources of information beyond the sources of information that would be identified if the only search terms or phrase was elevated liver function tests. An ontology-expanded list of search terms can relate to the adverse event(s), the drug(s), the ailment(s), or to any other component of the user's query. A query can be automatically subjected to the processor 38 or be subjected to the processor 38 at the request of the user. FIG. 4 shows that the ontology/NLP processor 38 contains SNOMED, SOPHIA, specific ontologies, and NLP, but it should be appreciated that other ontologies, including non-specific ontologies, drug ontologies, and other term-contextualizing systems can be employed. The SOPHIA search engine provides thematical search capability as opposed to traditional key word based search capability. With reference to FIG. 9, should the user want to do so, the user can edit the expanded search terms to either delete one or more terms or add one or more terms prior to the execution of a search or searches. FIG. 9 illustrates the situation in which the user has added terms to the ontology shown in FIG. 8. Once the user has decided on what set of terms to search, the application server 32 sends the request to the DBMS subsystem 34 which processes the request and uses a priority algorithm that prioritizes the search results based on many factors, including but not limited to number of search term hits within a specified section of a document, regulatory agency warnings (black box warnings etc.), frequency of an adverse event, and other prioritization weighting factors, AI derived or not.

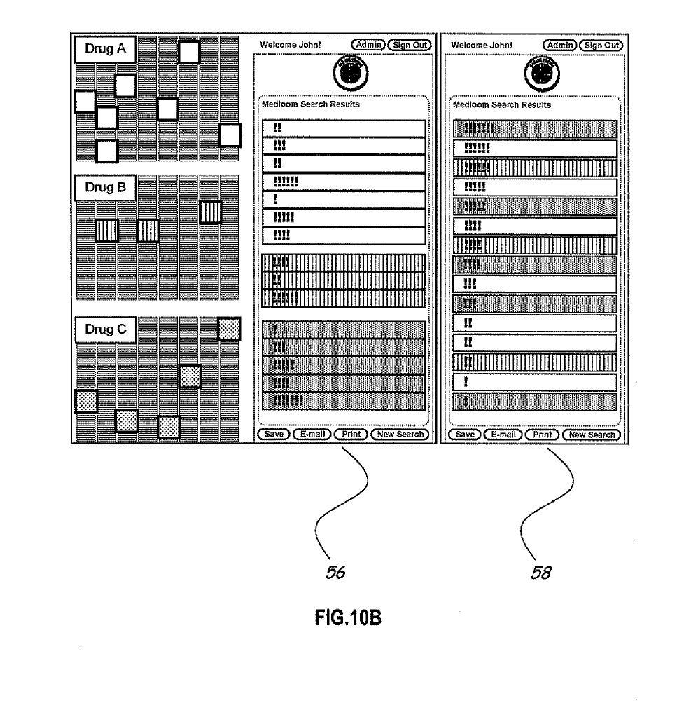

FIGS. 10A and 10B illustrates an example of a user-specified query, an ontology-based search term expansion of the user-specified query, an NLP driven search or mining operation relative to one or more data resources (e.g., databases and the like) to produce search results, the unprioritized search results, and the prioritized search results. More specifically, query input form 50 shows that a user has input a query with Drug A, Drug B, Drug C, and an adverse event of elevated liver function tests. An ontology-based search term expansion form 52 shows several of the ontologically identified additional search terms that relate to the adverse event of elevated liver function tests. Search term expansion is not limited to a user specified adverse event but can be applied to any combination of the terms or phrases in the query specified by the user. The form 52 has a “check box” next to each of the ontologically identified expansion terms that allows the user to select which of the ontologically identified search terms are to be used in a subsequent search based on the user-specified query terms and the selected, ontologically identified expansion terms. Display 54 illustrates the results, categorized according to the drug, of an NLP based search of one or more data resources that are available to the system 20. With reference to FIG. 10B, the results of the search categorized by drug and unprioritized are shown in display 56. Unprioritized results typically are not provided to the user. Consequently, the display 56 is typically not generated and not provided to the user. Nonetheless, display 56 is useful for illustrating unprioritized results. The unprioritized nature of the results is reflected in the number of “bangs” or “hits” associated with each reference in the search results. For instance, the first three results associated with Drug A respectively have two bangs, three bangs, and two bangs. Display 58, in contrast, illustrates the prioritized results that are provided to the user. In display 58, the results are no longer categorized by drug but rather by the number of bangs, the top item in the list being associated with Drug B and having seven bangs and the bottom item being associated with Drug C and having one bang.

The processing engine 26 is further capable of: (a) storing a client query and a copy of each source of information that was identified in the results provided to the user as a result of the processing of the query, (b) at one or more specified times that can be default times set by the system or times specified by the user, compare each source of information that was identified in the results provided to the user to a new copy of the source of information, and (c) if a source of information has changed since the results to the query were provided to the user, inform the user that there has been a change and identify the change to the user. The user can then assess whether the change is significant with respect to a particular individual or patient.

The processing engine 26 is also capable of: (a) storing a drug(s) or ailment(s) or combinations thereof, (b) at one or more specified times that can be default times established by the system or times specified by a user, cause one or more searches of databases maintained by the system and/or accessible to the system to determine if an adverse event that satisfies the specified criteria has been reported; and (c) if such an adverse event is identified, report the adverse event and relevant information sources to the user via the user's electronic or computing device. Further, the processing engine 26 is capable of searching the database of EMRs, de-identified or otherwise, provided by a user to identify those patients, anonymous or otherwise, that may now be at risk based on the user specified search parameters and identify those patients, anonymous or otherwise, to the user. Alternatively, the results of the search can be provided to the user's EMR system by, for example, the HL7 port of the server 28. The user can then run a search on their EMR system to identify the patients potentially at risk. It should be appreciated that the ability of the system 20 to make use of post-marketing drug safety data from various countries around the world, where the same drug may be approved for different diseases, provides benefits to healthcare professionals that include an increased awareness of safety risks associated with off-label drug prescription practice when otherwise such data would not be available in the country where the drug is not approved for that particular disease.

Another function that the processing engine is capable of performing is the monitoring of “hits,” i.e., the identification of patients that are potentially at risk when either the de-identified EMRs are searched or a user searches their EMR system when an adverse event is identified based on user specified criteria of drug(s), ailment(s), or combinations thereof. In the case when an adverse event is reported to the user and the user searches their EMR system for patients that may be at risk of the adverse event, a “plug-in” program or comparable device that resides in the user's EMR system is used to monitor hits and report hits back to the system 20. It should be appreciated that hits can be used to quantify the benefit of the system 20 to the user. Further, such quantification can be provided to the user via a visual display of metrics, i.e., a display that is present on one or more pages of the user's electronic or computing device and shows, for example, the number of hits that the system has identified for the user. This information can also be used to place a monetary value on the benefit of the system 20 to the user.

To utilize the system 20, a user initially establishes a communication link with the system 20 via the user interface 22. The link can be established with a communication device that has a web browser or with any other suitable communication device that utilizes a messaging protocol supported by the system 20. In any event, after the communication link is established, the user has an interface that allows the user to (a) input queries to the processing engine 26 and (b) receive the results of a search conducted by the processing engine 26 based on a query. More specifically, the system 20 provides the user's communication device with a form that is displayed on a monitor (or other suitable display device) associated with the user's communication device. The user inputs a query by entering data into one or more of the fields associated with the form. Data can be entered using whatever input peripherals the user's communication device supports and that are capable of entering suitable data. Typically, the input peripheral is a keyboard. However; other input peripherals are also feasible (e.g., touch screen, light pen, microphone etc.) The system 20 is capable of receiving and processing at least each of the following queries:

(a) (i) Adverse Event (AE) experienced by patient and (ii) known ailments of the patient;

(b) (i) AE experienced by patient and (ii) drug(s)) and/or treatment(s) applied to the patient;

(c) (i) AE experienced by patient, (ii) drug(s) and/or treatments(s) applied to the patient, and (iii) known ailments of the patient;

With respect to any such query, the user is also capable of using a form displayed on the monitor or other display peripheral associated with the user's communication device to inform the system 20 that a particular query is to be subjected to an ontology-based search term expansion. The form also allows the user to edit any ontology-based search term expansion before and/or after a search based on a query. The ontology-based search term expansion can be based on any ontology. However, sophisticated search engines, like SOPHIA, that implement a thematical search approach provide additional, relevant search terms that may or may not be used to supplement the ontology-based search term expansion results.

The search can be based on the query as specified by the user, or a search based upon the query specified by the user and subsequently subjected to ontology-based search term expansion.

The received results are typically displayed on the monitor associated with the user's communication device. As an alternative or in addition to displaying the results on a monitor, the results can be provided to any suitable peripheral associated with the user's communication device. For example, the results can be sent to a storage device (e.g., tape drive, disk drive etc.) and/or to a printer.

A form displayed on the monitor or other display peripheral associated with the user's communication device allows a user to request that the system 20: (a) store or identify a particular query and store a copy of each reference identified when the specified query was initially processed; (b) one or more times after the initial results have been produced, compare each of the references identified when the query was initially processed to an updated copy of the reference; and (c) inform the user if there has been a change in one or more of the references. The processing engine 28 processes the request and informs the user if there has been a change in a reference by a message that the processing engine 28 provides to the user's communication device for display on the monitor or other display peripheral associated with the user's communication device.

A form displayed on the monitor or other display peripheral associated with the user's communication device allows a user to request that it be informed of a future, documented adverse event that is associated with a drug(s) and/or ailment(s) or combinations thereof identified by the user in the form. Subsequently, the processing engine 28 conducts a search based upon the user specified information. If the processing engine 28 identifies an adverse event that has been documented after any prior search based on the specified information and the current search based on the information, the engine 28 causes a message to be provided to the user's communication device for display on the monitor or other display peripheral associated with the user's communication device. The user can use this information to query its own EMR system to determine if there is a patient(s) at risk, or the user can indicate that the system search through the user's EMR system to identify if there is a patient(s) at risk.

The communications between the system 20 and the user's communication device can be conducted over a wide-area network or local-area network. Alternatively, the searching and reporting capability of the system 20 can be implemented in a stand-alone computer system.

What is claimed is:

1. A method for providing a user with medical assessment support information comprising:
establishing a communication link with a medical assessment support system using an electronic communication device;
sending a query to a medical assessment support system using said electronic communication device, said query comprising an identification of a known ailment of a patient and an identification of adverse event experienced by the patient;
receiving, in response to said step of sending, results of a database search conducted by a medical assessment support system and based upon said query.

2. A method, as claimed in claim 1, wherein:
said medical assessment query further comprising an identification of a drug/treatment having been applied to the patient.

3. A method, as claimed in claim 1, wherein:
said results being the product of an ontology-based search term expansion of at least one of: (a) said known ailment and (b) said adverse event.

4. A method, as claimed in claim 1, wherein:
said results being the product of an ontology-based search term expansion of both: (a) said known ailment and (b) said adverse event.

5. A method, as claimed in claim 1, wherein:
said results being the product of natural language process searching based upon said query.

6. A method, as claimed in claim 1, wherein:
said results being the product of (a) ontology-based search term expansion of at least a portion of said query and (b) searching of a database based upon natural language processing of said query and any additional search terms resulting from the ontology-based search term expansion.

7. A method, as claimed in claim 1, wherein:
said step of sending further comprising requesting an ontology-based search term expansion of at least a portion of said query.

8. A method, as claimed in claim 1, further comprising:
receiving, from said medical assessment support system and prior to said step of receiving results, additional search terms based on an ontology-based search term expansion of at least a portion of said query.

9. A method, as claimed in claim 8, further comprising:
providing, following said step of receiving additional search terms and prior to said step of receiving results, amended additional search terms to said medical assessment support system.

10. A method, as claimed in claim 9, wherein:
said amended additional search terms do not have all of said additional search terms.

11. A method, as claimed in claim 9, wherein:
said amended additional search terms has at least one term not in said additional search terms.

12. A method, as claimed in claim 1, wherein:
said results are prioritized based on one or a combination of: (a) the number of terms in said query that are found in predetermined section of a document; (b) regulatory agency mandated prioritization; and (c) frequency of an adverse event.

13. A method, as claimed in claim 1, further comprising:
receiving, following said step of receiving results, a message that a reference identified in said results has changed.

14. A system for providing medical assessment support to a healthcare provider or other individual, comprising:
an user interface for receiving a query from an electronic communication device associated with a healthcare provider or other individual and sending the results of a search based on said query to an electronic communication device associated with the healthcare provider or other individual;
a processing engine for searching at least one data source based upon a query received by said input interface and providing said search results to said user interface for subsequent transmission to an electronic communication device associated with the healthcare provider or other individual, said query identifying:
(a) a known ailment of a patient and an adverse event experienced by the patient;
(b) a known ailment of a patient, a drug/treatment having been applied to the patient, and an adverse event experienced by the patient; or
(c) drugs and/or treatments having been applied to the patient and an adverse event experienced by the patient;
wherein said processing engine comprises an ontology processor for processing at least a portion of said query to produce additional search terms;
wherein said processing engine comprises a natural language processor for searching at least one database based on said query and said additional search terms;
wherein said processing engine comprises a prioritizer for prioritizing the results produced by the natural language processor; and
a data interface for conducting communications with an external data source that may be able to provide information that is relevant to a query.

15. A system, as claimed in claim 14, wherein:
said processing engine comprises a comparator for comparing an old version of a reference identified in the results of search based on a query to an updated version of said reference and, if there is a difference, providing a message relating to the difference to said user interface for subsequent transmission to an electronic communication device associated with the user.

16. A system, as claimed in claim 14, wherein:
said query is a repeating query that identifies (a) one or more drugs/treatments being applied to a patient and/or (b) one or more ailments being experienced by a patient;
said processing means repeatedly searching for adverse events based on said repeating query.
